(19) United States
(12) Patent Application Publication
(10) Pub. No.: US 2010/0103840 A1
(43) Pub. Date: Apr. 29, 2010

(54) Techniques for LDPC decoding

(76) Inventors: Chih C. Tsien, San Diego, CA (US); Jiewen Liu, San Diego, CA (US)

Correspondence Address: INTEL CORPORATION;c/o CPA Global, P.O. BOX 52050, MINNEAPOLIS, MN, 55402, US

(21) Appl. No.: 12/655,088

(22) Filed: Dec. 23, 2009

Related U.S. Application Data
(63) Continuation of application No. 10/615,471, filed on Jul. 7, 2003.

(51) Int. Cl. H04L 12/26

(52) U.S. Cl. 370/252

(57) ABSTRACT

Briefly, in accordance with one embodiment of the invention, a device may dynamically select a frequency on which to communicate on a wireless local area network by determining which channels are available and which are unoccupied, for example using a received signal power level measurement. A linear folding algorithm may be used to select an available channel at a midpoint in a larger gap between occupied channels. In the event there are multiple larger gaps of the same size, the larger gap at the higher frequency may be selected.

### BACKGROUND OF THE INVENTION

Wireless local area network (WLAN) equipment and radar equipment operating at the 5 GHz band may interfere with each other when operating at the same frequencies and within the operating range. In order to protect radar operation, the WLAN system or device should detect radar signals first to avoid collision with the radar channel during a initiate and run-time phases. In addition, the WLAN device should spread the channels uniformly across the entire band to reduce the accumulated interference to radar and other services such as satellite communication.

### DESCRIPTION OF THE DRAWING FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a wireless local area network communication system in accordance with one embodiment of the present invention;

FIG. 2 is a flow diagram of a method for dynamic frequency selection in accordance with one embodiment of the present invention; and

FIG. 3 is a channel diagram illustrating a method for dynamic frequency selection in a wireless local area network in accordance with one embodiment of the present invention.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Some portions of the detailed description that follows are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as processing, computing, calculating, determining, or the like, refer to the action or processes of a computer or computing system, or similar electronic computing device, that manipulate or transform data represented as physical, such as electronic, quantities within the registers or memories of the computing system into other data similarly represented as physical quantities within the memories, registers or other such information storage, transmission or display devices of the computing system.

Embodiments of the present invention may include apparatuses for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMs, magnetic-optical disks, read-only memories (ROMs), random access memories (RAMs), electrically programmable read-only memories (EPROMs), electrically erasable and programmable read only memories (EEPROMs), flash memory, magnetic or optical cards, or any other type of media suitable for storing electronic instructions, and capable of being coupled to a system bus for a computing device.

The processes and displays presented herein are not inherently related to any particular computing device or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

In the following description and claims, the terms coupled and connected, along with their derivatives, may be used. In particular embodiments, connected may be used to indicate that two or more elements are in direct physical or electrical contact with each other. Coupled may mean that two or more elements are in direct physical or electrical contact. However, coupled may also mean that two or more elements may not be in direct contact with each other, but yet may still cooperate or interact with each other.

It should be understood that embodiments of the present invention may be used in a variety of applications. Although the present invention is not limited in this respect, the circuits disclosed herein may be used in many apparatuses such as in the transmitters and receivers of a radio system. Radio systems intended to be included within the scope of the present invention include, by way of example only, wireless local area networks (WLAN) devices and wireless wide area network (WWAN) devices including wireless network interface devices and network interface cards (NICs), base stations, access points (APs), gateways, bridges, hubs, cellular radiotelephone communication systems, satellite communication systems, two-way radio communication systems, one-way pagers, two-way pagers, personal communication systems (PCS), personal computers (PCs), personal digital assistants (PDAs), and the like, although the scope of the invention is not limited in this respect.

Types of wireless communication systems intended to be within the scope of the present invention include, although not limited to, Wireless Local Area Network (WLAN), Wireless Wide Area Network (WWAN), Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like, although the scope of the invention is not limited in this respect.

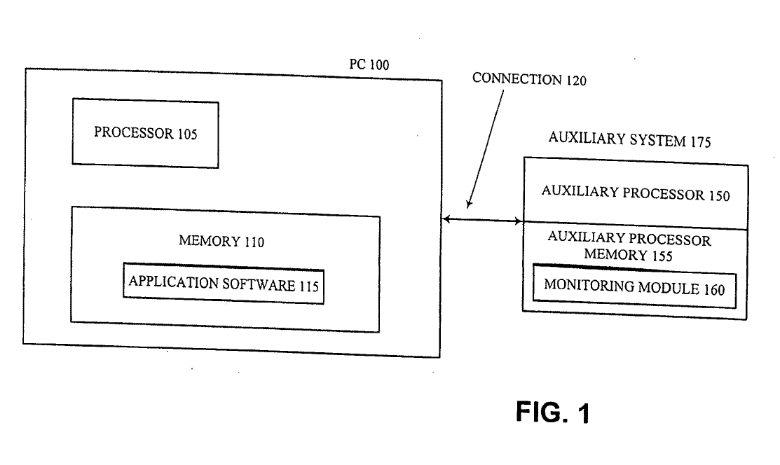

Referring now to FIG. 1, a wireless local area network communication system in accordance with one embodiment of the present invention will be discussed. In the WLAN communications system 100 shown in FIG. 1, a mobile unit 110 may include a wireless transceiver 112 to couple to an antenna 118 and to a processor 114 to provide baseband and media access control (MAC) processing functions. Processor 114 in one embodiment may comprise a single processor, or alternatively may comprise a baseband processor and an applications processor, although the scope of the invention is not limited in this respect. Processor 114 may couple to a memory 116 which may include volatile memory such as DRAM, non-volatile memory such as flash memory, or alternatively may include other types of storage such as a hard disk drive, although the scope of the invention is not limited in this respect. Some portion or all of memory 116 may be included on the same integrated circuit as processor 114, or alternatively some portion or all of memory 116 may be disposed on an integrated circuit or other medium, for example a hard disk drive, that is external to the integrated circuit of processor 114, although the scope of the invention is not limited in this respect.

Mobile unit 110 may communicate with access point 122 via wireless communication link 132, where access point 122 may include at least one antenna 120. In an alternative embodiment, access point 122 and optionally mobile unit 110 may include two or more antennas, for example to provide a spatial division multiple access (SDMA) system or a multiple input, multiple output (MIMO) system, although the scope of the invention is not limited in this respect. Access point 122 may couple with network 130 so that mobile unit 110 may communicate with network 130, including devices coupled to network 130, by communicating with access point 122 via wireless communication link 132. Network 130 may include a public network such as a telephone network or the Internet, or alternatively network 130 may include a private network such as an intranet, or a combination of a public and a private network, although the scope of the invention is not limited in this respect. Communication between mobile unit 110 and access point 122 may be implemented via a wireless local area network (WLAN), for example a network compliant with a an Institute of Electrical and Electronics Engineers (IEEE) standard such as IEEE 802.11a, IEEE 802.11b, HiperLAN-II, and so on, although the scope of the invention is not limited in this respect. In another embodiment, communication between mobile unit 110 and access point 122 may be at least partially implemented via a cellular communication network compliant with a 3GPP standard, although the scope of the invention is not limited in this respect.

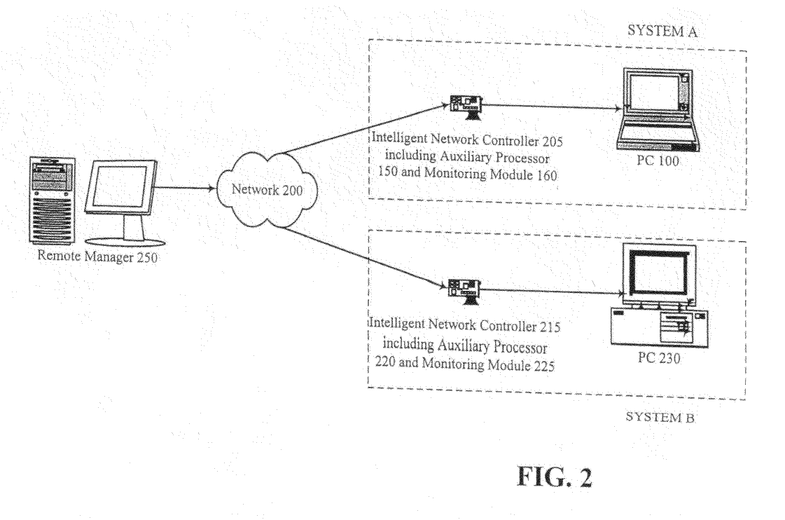

Referring now to FIG. 2, a flow diagram of a method for dynamic frequency selection in a wireless local area network in accordance with one embodiment of the invention will be discussed. As shown in FIG. 2, when the method starts at block 210, mobile unit 110 may scan most or all of the channels at the 5 GHz band at block 212, for example in the band from 5150 MHz to 5725 MHz, and may record the received signal power level (RPL) values at each channel. An RPL threshold may be set at block 214 to a predetermined value, for example −85 dBm. For each channel, the difference, delta, between the predetermined RPL threshold and the measured RPL may be calculated at block 216. A determination may be made at block 218 whether the delta is greater than zero, and if so then channels that having a delta greater than zero may be considered as occupied and are marked as occupied in a channel database. If the delta is less than zero, then a determination may be made at block 222 whether the delta is less than or equal to −3 dB, and if so then channels having a delta less than or equal to −3 dB may be considered as available and are marked as available in the channel database. A determination may be made at block 226 whether most or all channels have been scanned, and if not, then the method 200 continues at block 212 until most or all channels have been scanned, although the scope of the invention is not limited in this respect.

Once most or all of the channels have been scanned and determined to be occupied or available, the largest gap or gaps between available channels are found at block 228, and a determination may be made at block 230 whether there are multiple gaps of the same size between available channels. In the event there are multiple gaps of the same size between channels, then the gap located at a higher channel is selected. The middle of the largest gap, or the middle of the gap with located at a higher channel, may be selected as the channel for communication at block 234. A determination may be made at block 236 whether a collision occurs at the selected channel, and if not, mobile station 110 may communicate on the selected channel. In the event a collision is detected, then the method 200 may restart from the beginning at block 212 until an available channel is found, although the scope of the invention is not limited in this respect.

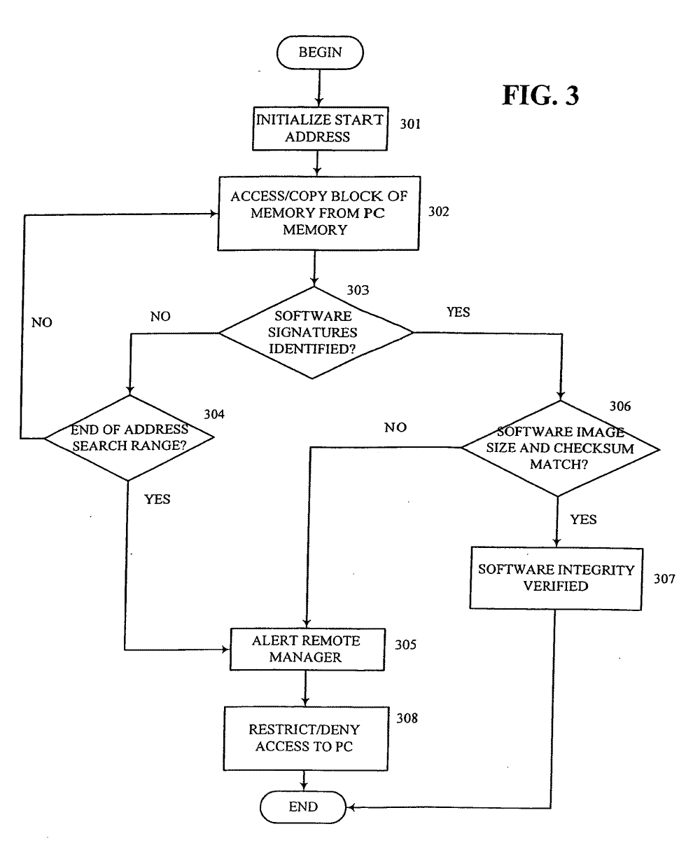

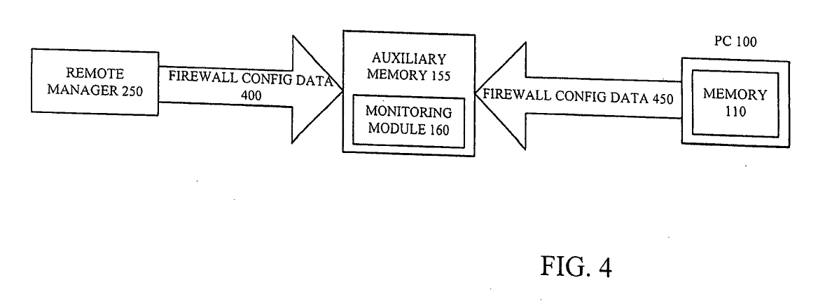

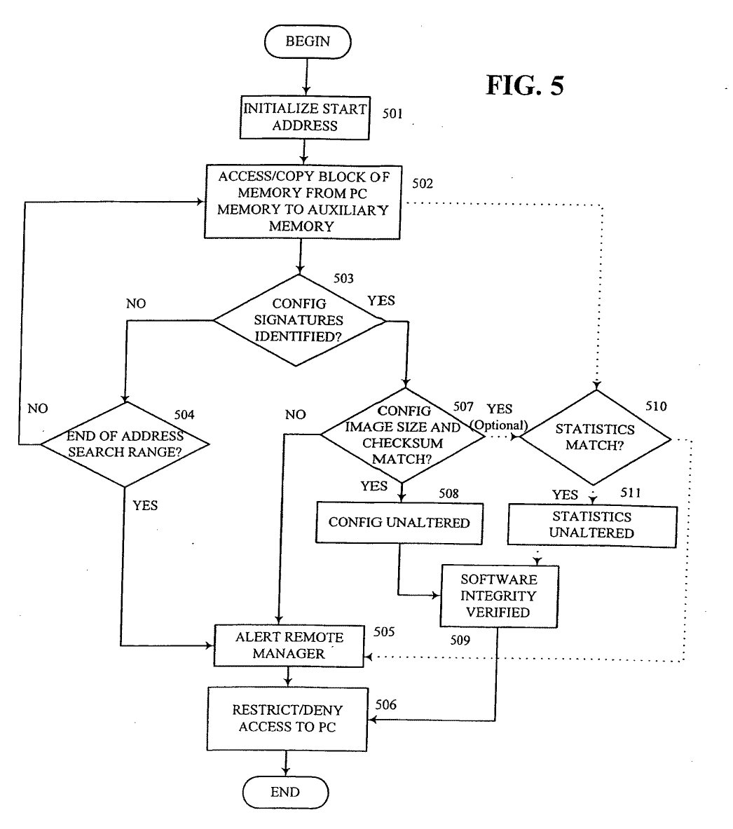

Referring now to FIG. 3, a channel diagram illustrating a method for dynamic frequency selection in a wireless local area network in accordance with one embodiment of the invention will be discussed. In FIG. 3, the horizontal axes represent frequency, and the vertical bars represent occupied channels. As shown in FIG. 3, occupied channels are indicated at 310, 312, 314, 316, 318, 320, and 322. In accordance with the method 200 discussed with respect to FIG. 2, channel A may be assigned at a point midway between occupied channel 320 and occupied 322, subsequent to which channel A may be occupied. In assigning channel B, channel B may be selected at a point midway between channel A and channel 322. Since the gap between channel 320 and channel A, and the gap between channel A and channel 322, channel B is assigned to the gap between channel A and channel 322 since this gap is associated with the higher frequency at channel 322 and will result in a higher frequency assignment for channel B, although the scope of the invention is not limited in this respect. For the assignment of channel C, channel C is assigned to the midpoint of the gap between channel 320 and channel A since this gap is the largest available gap. Channel D may be assigned to the gap between channel B and channel 322 since that gap is the largest gap at the higher frequency. Likewise, channel E may be assigned to the gap between channel A and channel B since this is the largest gap at the higher frequency, and then channel E likewise may be assigned to the gap between channel C and channel A, such a dynamic frequency selection algorithm may be considered as a linear folding algorithm to provide uniform channel spreading, although the scope of the invention is not limited in this respect.

Although the invention has been described with a certain degree of particularity, it should be recognized that elements thereof may be altered by persons skilled in the art without departing from the spirit and scope of the invention. It is believed that the dynamic frequency selection in a wireless local area network of the present invention and many of its attendant advantages will be understood by the forgoing description, and it will be apparent that various changes may be made in the form, construction and arrangement of the components thereof without departing from the scope and spirit of the invention or without sacrificing all of its material advantages, the form herein before described being merely an explanatory embodiment thereof, and further without providing substantial change thereto. It is the intention of the claims to encompass and include such changes.

What is claimed is:

1. A method, comprising:
scanning available channels;
measuring a received signal power level for the channels scanned in said scanning;
comparing the measured received signal power level to a threshold value to provide a difference; and
if the difference is greater than a predetermined value, then indicating the channel as occupied, otherwise indicating the channel as available.

2. The method of claim 1, further comprising:
determining a larger gap between available channels; and
selecting a channel within the larger gap.

3. A method as claimed in claim 2, further comprising determining whether a collision is detected at the channel selected in said selecting, and, if a collision is detected, selecting a new channel by executing the method again at said scanning.

4. A method as claimed in claim 3, wherein said selecting includes selecting a channel at a midpoint within the larger gap.

5. A method as claimed in claim 3, wherein in the event there are two or more larger gaps, selecting a larger gap at a higher frequency, wherein said selecting includes selecting a channel within the larger gap at a higher frequency.

6. A method as claimed in claim 3, wherein in the event there are two or more larger gaps, selecting a larger gap at a higher frequency, wherein said selecting includes selecting a channel within a midpoint of the larger gap at a higher frequency.

7. A method as claimed in claim 3, further comprising determining whether a collision is detected at the channel selected in said selecting, and, if a collision is detected, selecting a new channel by executing the method again at said scanning.

8. An article comprising a storage medium having stored thereon instructions that, when executed by a computing platform, result in dynamic frequency selection in a wireless local area network by:
scanning available channels;
measuring a received signal power level for the channels scanned in said scanning;
comparing the measured received signal power level to a threshold value to provide a difference;
if the difference is greater than a predetermined value, then indicating the channel as occupied, otherwise indicating the channel as available; and
selecting a channel from a channel indicated as available.

9. An article comprising a storage medium having stored thereon instructions that, when executed by a computing platform, result in dynamic frequency selection in a wireless local area network by:
scanning available channels;
measuring a received signal power level for the channels scanned in said scanning;
comparing the measured received signal power level to a threshold value to provide a difference;
if the difference is greater than a predetermined value, then indicating the channel as occupied, otherwise indicating the channel as available;
determining a larger gap between available channels; and
selecting a channel within the larger gap.

10. An article as claimed in claim 9, wherein said selecting includes selecting a channel at a midpoint within the larger gap.

11. An article as claimed in claim 9, wherein the instructions when executed further result in dynamic frequency selection in a wireless local area network by, in the event there are two or more larger gaps, selecting a larger gap at a higher frequency, wherein said selecting includes selecting a channel within the larger gap at a higher frequency.

12. An article as claimed in claim 9, wherein the instructions when executed further result in dynamic frequency selection in a wireless local area network by, in the event there are two or more larger gaps, selecting a larger gap at a higher frequency, wherein said selecting includes selecting a channel within a midpoint of the larger gap at a higher frequency.

13. An article as claimed in claim 9, wherein the instructions when executed further result in dynamic frequency selection in a wireless local area network by determining whether a collision is detected at the channel selected in said selecting, and, if a collision is detected, selecting a new channel by executing the method again at said scanning.

14. An apparatus, comprising:
a transceiver; and
a baseband processor to couple to said transceiver, wherein said baseband processor is capable of dynamically selecting a frequency on which to communicate via said transceiver on a wireless local area network by:
scanning available channels;
measuring a received signal power level for the channels scanned in said scanning;
comparing the measured received signal power level to a threshold value to provide a difference;
if the difference is greater than a predetermined value, then indicating the channel as occupied, otherwise indicating the channel as available;
determining a larger gap between available channels;
in the event there are two or more larger gaps, selecting a larger gap at a higher frequency; and
selecting a channel from a channel indicated as available within the larger gap at a higher frequency.

15. An apparatus as claimed in claim 14, wherein said baseband processor is further capable of dynamically selecting a frequency on which to communicate via said transceiver by determining a larger gap between available channels, in the event there are two or more larger gaps, selecting a larger gap at a higher frequency, wherein said selecting includes selecting a channel within a midpoint of the larger gap at a higher frequency.

16. An apparatus, comprising:
a transceiver; and
a baseband processor to couple to said transceiver, wherein said baseband processor is capable of dynamically selecting a frequency on which to communicate via said transceiver on a wireless local area network by:
scanning available channels;
measuring a received signal power level for the channels scanned in said scanning;
comparing the measured received signal power level to a threshold value to provide a difference; and
if the difference is greater than a predetermined value, then indicating the channel as occupied, otherwise indicating the channel as available.

17. The apparatus of claim 16, further comprising said baseband processor further:
determining a larger gap between available channels; and
selecting a channel within the larger gap.
